(19) United States
(12) Patent Application Publication
(10) Pub. No.: US 2007/0019886 A1
(43) Pub. Date: Jan. 25, 2007

(54) Adaptive image scaler for optimizing output image quality on the basis of input image signal and method thereof

(75) Inventor: Jea-Hee Han, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/391,456

(22) Filed: Mar. 29, 2006

(30) Foreign Application Priority Data
Jul. 20, 2005 (KR) 2005-65900

(51) Int. Cl. G06K 9/32

(52) U.S. Cl. 382/298

(57) ABSTRACT

An adaptive image scaler for optimizing output image quality on the basis of an input image signal and a method thereof are disclosed. The adaptive image scaler comprises an image signal analyzer for analyzing an input image signal and outputting size information of horizontal and/or vertical components of the input image signal. The scaler further comprises a filter generator for calculating a filter coefficient to be used for scaling and generating a scaling filter on the basis of the calculated coefficient. The scaler further comprises an image processor for performing horizontal filtering and/or vertical filtering for the input image signal using the scaling filter.

### PRIORITY

This application claims the benefit under 35 U.S.C. § 119(a) of Korean Patent Application No. 2005-65900, filed Jul. 20, 2005, in the Korean Intellectual Property Office, the entire content of which is hereby incorporated by reference.

### BACKGROUND OF THE INVENTION

1. Field of the Invention

The present invention relates to an image scaler and a method thereof. More particularly, the present invention relates to an adaptive image scaler for optimizing output image quality on the basis of an input image signal and a method thereof, in which a filter corresponding to a size of an input image signal is automatically generated and adapted to provide optimized picture quality during image scaling.

2. Description of the Related Art

Since digital display devices such as liquid crystal display (LCD), digital-mirror device (DMD), and plasma display panel (PDP) have fixed resolution, images having various resolution formats that are input to the digital display devices require conversion in order to adapt to the resolution of a corresponding display device. If the size of the input image is different from that of the output image, a scaler is required for conversion of the size of the input image, in other words the resolution of the input image.

Generally, a scaler is designed to selectively use a scaling filter depending on the size of input and output images using four to five setting values previously set by each scaling ratio.

Such a scaler classifies a scaling ratio using several filters and assigns input signals depending on the classified scaling ratio. In this case, an optimized scaling filter corresponding to the input image signal is not used. For this reason, a fine pattern for the image is not obtained. This effect is more pronounced in an image composed of fine characters, such as a PC signal, than in moving images.

Meanwhile, in case of an expensive scaler, a filter corresponding to the size of the input image signal is manufactured by a product developer and stored in a memory of the scaler. However, the variance in image size presents a challenge to the product developer when considering various options for display devices to output the input image signal. It is difficult for a product developer to design an optimized filter suitable for an appropriate size of input image signal.

### SUMMARY OF THE INVENTION

Accordingly, exemplary embodiments of the present invention are directed to an adaptive image scaler for optimizing output image quality on the basis of an input image signal and a method thereof, which substantially address one or more problems mentioned above which are due to limitations and disadvantages of the related art.

An object of an exemplary embodiment of the present invention is to provide an adaptive image scaler for optimizing output image quality on the basis of an input image signal and a method thereof, in which a filter corresponding to a size of an input image signal is automatically generated and adapted to provide optimized picture quality during image scaling.

To achieve these and other objects and advantages according to exemplary embodiments of the present invention, an adaptive image scaler is provided that comprises an image signal analyzer for analyzing an input image signal and outputting size information of horizontal and vertical components of the input image signal. The adaptive image scaler further comprises a filter generator for calculating a filter coefficient to be used for scaling on the basis of the size information of the horizontal and vertical components of the input image signal and generating a scaling filter on the basis of the calculated coefficient, and an image processor for performing horizontal filtering and vertical filtering, respectively, for the input image signal using the scaling filter.

The image scaler further comprises a memory for storing the scaling filter according to the size of the horizontal and/or vertical components of the input image signal.

The image scaler further comprises a microcomputer for identifying whether the size information of the horizontal and/or vertical components of the input image signal are stored in memory.

The microcomputer can supply size information of the horizontal and/or vertical components of the input image signal to the filter generator in order to generate the scaling filter if the size information of the horizontal and/or vertical components of the input image signal has not been stored in memory.

In an exemplary embodiment of the present invention, the microcomputer stores the scaling filter generated by the filter generator in memory according to the size of the horizontal and/or vertical components of the input image signal.

The microcomputer can read the scaling filter corresponding to size information of the horizontal and/or vertical components of the input image signal and supply the scaling filter to the image processor if the size information of the horizontal and/or vertical components of the input image signal is stored in memory.

In another aspect of an exemplary embodiment of the present invention, an image display device comprises the image scaler in accordance with exemplary embodiments of the present invention.

In other aspect of an exemplary embodiment of the present invention, an image scaling method comprises analyzing an input image signal to determine size information of horizontal and/or vertical components of the input image signal, identifying whether the size information of the horizontal and/or vertical components of the input image signal is stored in memory, calculating a filter coefficient to be used for scaling on the basis of the size information of the horizontal and/or vertical components of the input image signal and generating a scaling filter on the basis of the calculated coefficient if the size information of the horizontal and/or vertical components of the input image signal has not been stored, and performing horizontal filtering and vertical filtering, respectively, for the input image signal using the scaling filter.

In an exemplary embodiment of the present invention, the scaling filter stores the size information according to the horizontal and/or vertical components of the input image signal.

### BRIEF DESCRIPTION OF THE DRAWINGS

The above aspects and exemplary features of the present invention will be more apparent by describing certain exemplary embodiments of the present invention with reference to the accompanying drawings, in which:

FIG. 1 is a block diagram illustrating an adaptive image scaler for optimizing output image quality on the basis of an input image signal according to an exemplary embodiment of the present invention; and

FIG. 2 is a flow chart illustrating an adaptive image scaling method for optimizing output image quality on the basis of an input image signal according to an exemplary embodiment of the present invention.

Throughout the drawings, like reference numbers should be understood to refer to like elements, features, and structures.

### DETAILED DESCRIPTION OF EXEMPLARY EMBODIMENTS

The matters exemplified in this description are provided to assist in a comprehensive understanding of various exemplary embodiments of the present invention disclosed with reference to the accompanying figures. Accordingly, those of ordinary skill in the art will recognize that various changes and modifications of the exemplary embodiments described herein can be made without departing from the scope and spirit of the claimed invention. Descriptions of well-known functions and constructions are omitted for clarity and conciseness.

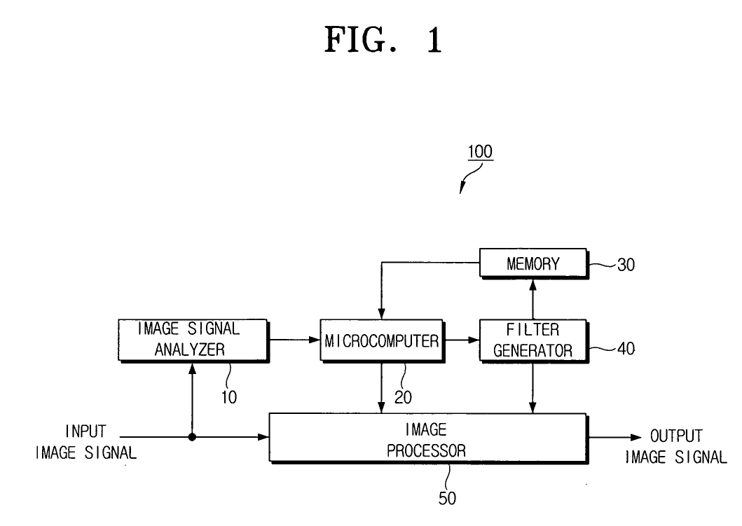

FIG. 1 is a block diagram illustrating an adaptive image scaler for optimizing output image quality on the basis of an input image signal according to an exemplary embodiment of the present invention.

Referring to FIG. 1, the adaptive image scaler 100 according to an exemplary embodiment of the present invention comprises an image signal analyzer 10, a microcomputer 20, a memory 30, a filter generator 40, and an image processor 50.

The image signal analyzer 10 analyzes an input image signal input from an external image source and supplies size information of the horizontal and/or vertical components of the input image signal to the microcomputer 20. Particularly, in an exemplary embodiment of the present invention, the microcomputer 20 supplies the information from the image signal analyzer 10 to the filter generator 40 so as to generate a scaling filter adapted to the input image signal. The filter generator 40 calculates a filter coefficient to be used for scaling on the basis of the information supplied from the microcomputer 20 and generates a final scaling filter using the calculated coefficient. Generally, examples of factors considered when calculating the coefficient comprise cut-off frequency, transition band, and filter tap, in addition to the size information of the horizontal and/or vertical components of the input image signal.

The cut-off frequency or transition band that determines characteristics of the boundary of the images is prescribed by the type of display device, such as LCD, PDP and DMD, and subjective and objective factors of a user (for example, evaluation of picture quality). The cut-off frequency and transition band have fixed values depending on the size of display screen. Also, the number of filter taps is determined as a fixed value depending on the performance of the image scaler.

The memory 30 stores the scaling filter generated in accordance with the sizes of the horizontal and/or vertical components of the input image signal. Therefore, if an image signal having the same horizontal and/or vertical components is input, the microcomputer 20 does not supply the size information of the horizontal and/or vertical components of the input image signal to the filter generator 40. Therefore, the filter generator 40 does not perform the process of calculating the filter coefficient. In other words, the microcomputer 20 supplies the scaling filter stored in the memory 30 to the image processor 50 in order to perform image scaling. The image processor 50 performs horizontal filtering and vertical filtering, respectively, for the input image signal using the scaling filter in order to output an image signal of desired resolution.

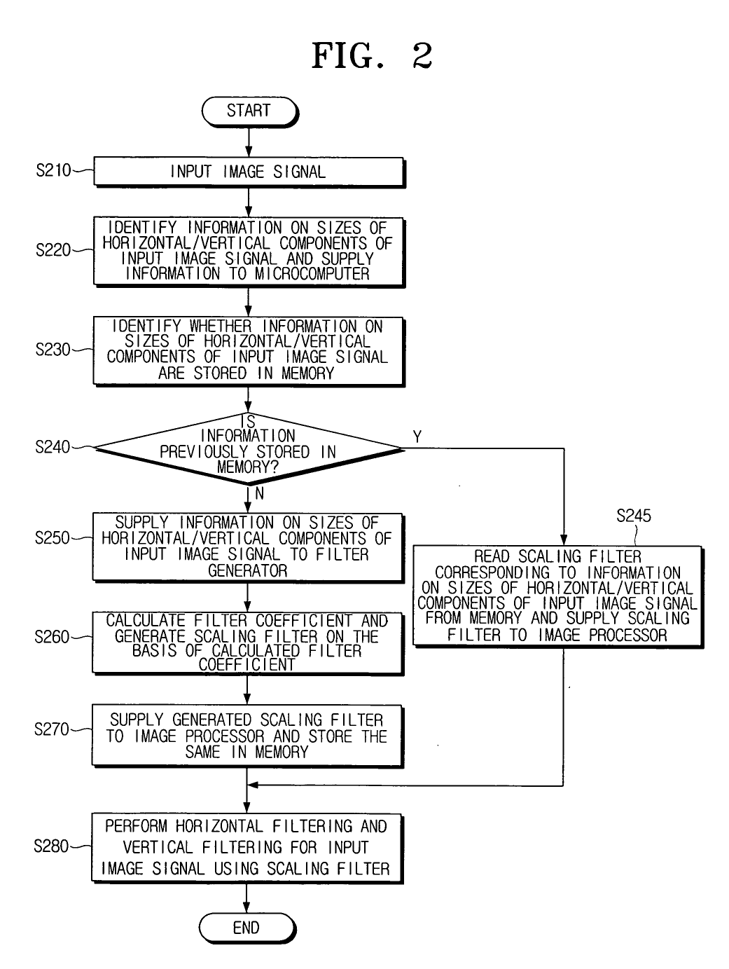

FIG. 2 is a flow chart illustrating an adaptive image scaling method for optimizing output image quality on the basis of an input image signal according to an exemplary embodiment of the present invention.

When an image signal is input from an outer image source, step S210, the image signal analyzer 10 analyzes the input image signal to identify size information of horizontal and/or vertical components of the input image signal and supplies the identified information to the microcomputer 20, step S220.

The microcomputer 20 identifies whether the information supplied from the image signal analyzer 10 is stored in memory 30, step S230, and tests whether the information has been stored, step S240.

If the information is has not been stored in memory 30, the microcomputer 20 supplies the size information of the horizontal and/or vertical components from the image signal analyzer 10 to the filter generator 40, step S250. The filter generator 40 then calculates the filter coefficient to be used for scaling on the basis of the information supplied from the microcomputer 20 and generates the final scaling filter on the basis of the calculated coefficient, step S260.

When the filter coefficient is calculated, cut-off frequency, transition band, and the number of taps of the filter in addition to the size information of the horizontal and/or vertical components of the input image signal are considered. However, if the cut-off frequency or the transition band, which determine characteristics of the boundary of the images, is prescribed by the type of display device, such as LCD, PDP and DMD, and subjective and objective factors of a user (for example, evaluation of picture quality), the image has a fixed value depending on the size of the device screen. Also, the number of taps of the filter is determined as a fixed value depending on the performance of the image scaler.

Therefore, among four factors considered when the filter coefficient is calculated, cut-off frequency, transition band, and the number of taps of the filter have initial values supplied by the product developer. These initial values serve as default values when no additional change is requested. By inputting non-default values into the scaler, users can directly control cut-off frequency, transition band, and the number of taps of the filter employed.

The scaling filter generated in step S260 is stored in the memory 30 under the control of the microcomputer 20 and at the same time is supplied to the image processor 50, step S270. At this time, the microcomputer 20 stores the scaling filter generated by the filter generator 40 in the memory 30 according to the size of the horizontal and/or vertical components of the input image signal. If an input image signal having the same size as the horizontal and/or vertical components is received later, it is possible to avoid the procedure of repeatedly generating the scaling filter.

Subsequently, the image processor 50 performs horizontal filtering and vertical filtering, respectively, for the input image signal using the scaling filter supplied from the filter generator 40 in order to output an image signal of desired resolution, step S280.

Meanwhile, as a result of step S230, if information on the size of the horizontal and/or vertical components of the input image signal supplied from the image signal analyzer 10 has been previously stored in memory 30, that is, a “yes” response occurs in step S240, the microcomputer 20 reads the scaling filter corresponding to the size information of the horizontal and/or vertical components of the input image signal from the memory 30 and supplies the information to the image processor 50, step S245.

The image processor 50 then performs horizontal filtering and vertical filtering, respectively, for the input image signal using the scaling filter supplied from the microcomputer 20 in order to output an image signal of desired resolution, step S280.

As described above, the adaptive image scaler for optimizing output image quality on the basis of the input image signal and the method thereof in accordance with exemplary embodiments of the present invention have the advantage of providing users with optimized picture quality because, for example, image scaling is performed using the scaling filter generated to adapt to the input image. Further, because, for example, the filter corresponding to the size of the input image signal does not need to be manufactured by the product developer, it is possible to reduce product development cost and time.

While the present invention has been particularly shown and described with reference to certain exemplary embodiments thereof, it will be understood by those of ordinary skill in the art that various changes in form and detail may be made therein without departing from the spirit and scope of the present invention as defined by the appended claims and equivalents thereof.

What is claimed is:

1. An image scaler comprising:
an image signal analyzer for analyzing an input image signal and outputting size information comprising a size of at least one horizontal and vertical components of the input image signal;
a filter generator for calculating a filter coefficient to be used for scaling on the basis of the size of the at least one of the horizontal and vertical components of the input image signal, and generating a scaling filter on the basis of the calculated filter coefficient; and
an image processor for performing at least one of horizontal filtering and vertical filtering for the input image signal using the scaling filter.

2. The image scaler as claimed in claim 1, further comprising a memory for storing the scaling filter according to the size of the at least one of the horizontal and vertical components of the input image signal.

3. The image scaler as claimed in claim 2, further comprising a microcomputer for identifying whether the memory comprises stored therein the size of the at least one of the horizontal and vertical components of the input image signal.

4. The image scaler as claimed in claim 3, wherein the microcomputer supplies the size of the at least one of the horizontal and vertical components of the input image signal to the filter generator if the size of the at least one of the horizontal and vertical components of the input image signal is not stored in the memory.

5. The image scaler as claimed in claim 4, wherein the microcomputer stores the scaling filter in the memory according to the size of the at least one of the horizontal and vertical components of the input image signal.

6. The image scaler as claimed in claim 3, wherein the microcomputer reads the scaling filter corresponding to the size of the at least one of the horizontal and vertical components of the input image signal and supplies the scaling filter to the image processor if the memory comprises stored therein the size information.

7. An image display device comprising the image scaler of claim 1.

8. An image scaling method comprising:
determining a size of at least one of a horizontal and vertical components of an input image signal;
identifying whether the size of the at least one of the horizontal and vertical components of the input image signal is stored;
calculating a filter coefficient for scaling based on the size information of the at least one of the horizontal and vertical components of the input image signal;
generating a scaling filter on the basis of the calculated filter coefficient if the size is not stored; and
performing at least one of horizontal filtering and vertical filtering for the input image signal using the scaling filter.

9. The image scaling method as claimed in claim 8, further comprising storing the scaling filter according to the size of at least one of the horizontal and vertical components of the input image signal.
